(19) United States
(12) Patent Application Publication
(10) Pub. No.: US 2025/0071856 A1
(43) Pub. Date: Feb. 27, 2025

(54) CELL DISCONTINUOUS TRANSMISSION OR CELL DISCONTINUOUS RECEPTION WITH CARRIER AGGREGATION

(71) Applicant: QUALCOMM Incorporated, San Diego, CA (US)

(72) Inventors: Hung Dinh LY, San Diego, CA (US); Wanshi CHEN, San Diego, CA (US)

(21) Appl. No.: 18/804,286

(22) Filed: Aug. 14, 2024

Related U.S. Application Data
(60) Provisional application No. 63/520,777, filed on Aug. 21, 2023.

(51) Int. Cl. H04W 76/28; H04B 7/06; H04W 72/23

(52) U.S. Cl. CPC H04W 76/28; H04B 7/0626; H04W 72/23

(57) ABSTRACT

Various aspects of the present disclosure generally relate to wireless communication. In some aspects, a user equipment (UE) may receive a configuration of cell discontinuous transmission or cell discontinuous reception. The UE may receive a configuration of carrier aggregation associated with a primary cell (Pcell) and a secondary cell (Scell). The UE may receive an indication to activate or deactivate the cell discontinuous transmission or cell discontinuous reception for the Pcell. The UE may skip, or monitoring for, based at least in part on the indication to activate or deactivate the cell discontinuous transmission or cell discontinuous reception for the Pcell, reception or transmission of one or more channels associated with the Scell. Numerous other aspects are described.

### CROSS-REFERENCE TO RELATED APPLICATION

This Patent application claims priority to U.S. Provisional Patent Application No. 63/520,777, filed on Aug. 21, 2023, entitled “CELL DISCONTINUOUS TRANSMISSION OR CELL DISCONTINUOUS RECEPTION WITH CARRIER AGGREGATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for cell discontinuous transmission (DTX) or cell discontinuous reception (DRX) with carrier aggregation (CA).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include one or more memories and one or more processors coupled to the one or more memories. The one or more processors may be configured to cause the UE to receive a configuration of cell discontinuous transmission (DTX) or cell discontinuous reception (DRX). The one or more processors may be configured to cause the UE to receive a configuration of carrier aggregation (CA) associated with a primary cell (Pcell) and a secondary cell (Scell). The one or more processors may be configured to receive an indication to activate or deactivate the cell DTX or cell DRX for the Pcell. The one or more processors may be configured to cause the UE to skip, or monitor for, based at least in part on the indication to activate or deactivate the cell discontinuous transmission or cell discontinuous reception for the Pcell, reception or transmission of one or more channels associated with the Scell.

Some aspects described herein relate to a network node for wireless communication. The network node may include one or more memories and one or more processors coupled to the one or more memories. The one or more processors may be configured to cause the network node to transmit a configuration of cell DTX or cell DRX. The one or more processors may be configured to transmit a configuration of CA associated with a Pcell and an Scell. The one or more processors may be configured to cause the network node to transmit an indication to activate or deactivate the cell DTX or cell DRX for the Pcell. The one or more processors may be configured to cause the network node to skip reception or transmission of, or transmit, based at least in part on the indication to activate or deactivate the cell DTX or cell DRX for the Pcell, one or more channels associated with the Scell.

Some aspects described herein relate to a method of wireless communication performed by a UE. The method may include receiving a configuration of cell DTX or cell DRX. The method may include receiving a configuration of CA associated with a Pcell and an Scell. The method may include receiving an indication to activate or deactivate the cell DTX or cell DRX for the Pcell. The method may include skipping, or monitoring for, based at least in part on the indication to activate or deactivate the cell DTX or cell DRX for the Pcell, reception or transmission of one or more channels associated with the Scell.

Some aspects described herein relate to a method of wireless communication performed by a network node. The method may include transmitting a configuration of cell DTX or cell DRX. The method may include transmitting a configuration of CA associated with a Pcell and an Scell. The method may include transmitting an indication to activate or deactivate the cell DTX or cell DRX for the Pcell. The method may include skipping reception or transmission of, or transmitting, based at least in part on the indication to activate or deactivate the cell DTX or cell DRX for the Pcell, one or more channels associated with the Scell.

Some aspects described herein relate to a non-transitory computer-readable medium that stores a set of instructions for wireless communication by a UE. The set of instructions, when executed by one or more processors of the UE, may cause the UE to receive a configuration of cell DTX or cell DRX. The set of instructions, when executed by one or more processors of the UE, may cause the UE to receive a configuration of CA associated with a Pcell and an Scell. The set of instructions, when executed by one or more processors of the UE, may cause the UE to receive an indication to activate or deactivate the cell DTX or cell DRX for the Pcell. The set of instructions, when executed by one or more processors of the UE, may cause the UE to skip, or monitor for, based at least in part on the indication to activate or deactivate the cell DTX or cell DRX for the Pcell, reception or transmission of one or more channels associated with the Scell.

Some aspects described herein relate to a non-transitory computer-readable medium that stores a set of instructions for wireless communication by a network node. The set of instructions, when executed by one or more processors of the network node, may cause the network node to transmit a configuration of cell DTX or cell DRX. The set of instructions, when executed by one or more processors of the network node, may cause the network node to transmit a configuration of CA associated with a Pcell and an Scell. The set of instructions, when executed by one or more processors of the network node, may cause the network node to transmit an indication to activate or deactivate the cell DTX or cell DRX for the Pcell. The set of instructions, when executed by one or more processors of the network node, may cause the network node to skip reception or transmission of, or transmit, based at least in part on the indication to activate or deactivate the cell DTX or cell DRX for the Pcell, one or more channels associated with the Scell.

Some aspects described herein relate to an apparatus for wireless communication. The apparatus may include means for receiving a configuration of cell DTX or cell DRX. The apparatus may include means for receiving a configuration of CA associated with a Pcell and an Scell. The apparatus may include means for receiving an indication to activate or deactivate the cell DTX or cell DRX for the Pcell. The apparatus may include means for skipping, or monitoring for, based at least in part on the indication to activate or deactivate the cell DTX or cell DRX for the Pcell, reception or transmission of one or more channels associated with the Scell.

Some aspects described herein relate to an apparatus for wireless communication. The apparatus may include means for transmitting a configuration of cell DTX or cell DRX. The apparatus may include means for transmitting a configuration of CA associated with a Pcell and an Scell. The apparatus may include means for transmitting an indication to activate or deactivate the cell DTX or cell DRX for the Pcell. The apparatus may include means for skipping reception or transmission of, or transmitting, based at least in part on the indication to activate or deactivate the cell DTX or cell DRX for the Pcell, one or more channels associated with the Scell.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of cell discontinuous transmission (DTX) and/or cell discontinuous reception (DRX), in accordance with the present disclosure.

FIG. 5 is a diagram illustrating an example of cell DTX cycle activation or deactivation, in accordance with the present disclosure.

FIG. 6 is a diagram illustrating examples of carrier aggregation (CA), in accordance with the present disclosure.

FIG. 7 is a diagram illustrating an example associated with cell DTX/DRX with CA, in accordance with the present disclosure.

FIG. 8 is a diagram illustrating an example associated with skipping reception or transmission of one or more channels associated with a secondary cell (Scell) beginning at when a cell DTX for a primary cell (Pcell) is activated, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a network node or an apparatus of a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Cell discontinuous transmission (DTX) and/or cell discontinuous reception (DRX) (cell DTX/DRX), which may be used for network energy savings, may be supported for both single carrier and carrier aggregation (CA) scenarios. As a result, the UE may support both cell DTX/DRX and CA simultaneously, which can impact UE processing, especially when the cell DTX/DRX patterns across secondary cells (Scells) are not aligned. For example, a network node may turn off one or more Scells when network energy savings is needed, and turn on one or more Scells when network energy savings is not needed, via an Scell activation/deactivation procedure (e.g., instead of applying cell DTX/DRX). However, being radio resource control (RRC) based, Scell activation/deactivation may be associated with a latency that can lead to inefficiencies. For example, because downlink control information (DCI) is generally associated with lower latency than RRC, RRC-based Scell activation/deactivation may lag behind DCI-based cell DTX/DRX activation/deactivation. For instance, this latency can cause the Scells to remain activated for some time after the cell DTX/DRX is activated, which can consume energy.

Various aspects relate generally to cell DTX/DRX in CA. Some aspects more specifically relate to imposing restrictions on Scells when a UE supports simultaneous CA and cell DTX/DRX. In some examples, a network node may transmit, and a UE may receive, a configuration of cell DTX or cell DRX, a configuration of CA associated with a Pcell and an Scell, and an indication to activate or deactivate the cell DTX or cell DRX for the Pcell. The network node may skip reception or transmission of, or transmit, based at least in part on the indication to activate or deactivate the cell discontinuous transmission or cell discontinuous reception for the Pcell, one or more channels associated with the Scell. The UE may skip, or monitor for, based at least in part on the indication to activate or deactivate the cell discontinuous transmission or cell discontinuous reception for the Pcell, reception or transmission of one or more channels associated with the Scell.

In some aspects, the network node may skip the reception or transmission of the one or more channels associated with the Scell by refraining from transmitting a physical downlink control channel (PDCCH) associated with the Scell, and the UE may skip the reception or transmission of the one or more channels associated with the Scell by refraining from monitoring the PDCCH associated with the Scell. In some aspects, the network node and the UE may skip the reception or transmission of the one or more channels associated with the Scell based at least in part on cell discontinuous transmission or cell discontinuous reception for the Scell. In some aspects, the network node may skip the reception or transmission of the one or more channels associated with the Scell by refraining from transmitting a PDCCH associated with the Scell, the UE may skip the reception or transmission of the one or more channels associated with the Scell by refraining from monitoring the PDCCH associated with the Scell, and network node and the UE may further skip the reception or transmission of the one or more channels associated with the Scell by refraining from monitoring for or transmitting scheduled uplink or downlink data associated with the Scell.

Particular aspects of the subject matter described in this disclosure can be implemented to realize one or more of the following potential advantages. In some examples, by performing the skipping, transmitting, and/or monitoring with respect to the channel(s) associated with the Scell, the described techniques can be used to avoid RRC-based Scell activation/deactivation while supporting cell DTX/DRX. For example, the skipping, monitoring, and/or transmission may be based on the cell DTX or cell DRX activation/deactivation indication for the Pcell (e.g., rather than an RRC-based Scell activation/deactivation indication). Therefore, the latency caused by RRC-based Scell activation/deactivation may be reduced or eliminated. Allowing both CA and cell DTX/DRX to be supported simultaneously while impose certain restrictions on Scells, as described herein, may enable fast Scell activation/deactivation and thereby reduce power consumption (e.g., UE power consumption).

Refraining from monitoring or transmitting a PDCCH associated with the Scell may mimic deactivation of the Scell, thereby enabling the UE to reduce power consumption (e.g., over both active and non-active periods). Skipping the reception or transmission of the one or more channels associated with the Scell based at least in part on cell discontinuous transmission or cell discontinuous reception for the Scell may enable the UE to use the Scell while providing network energy savings to the network node. Refraining from monitoring or transmitting a PDCCH associated with the Scell and refraining from monitoring for or transmitting scheduled uplink or downlink data associated with the Scell may confer energy savings to the network node and the UE, which may each avoid monitoring for and/or transmitting PDCCH and/or scheduled uplink or downlink data.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

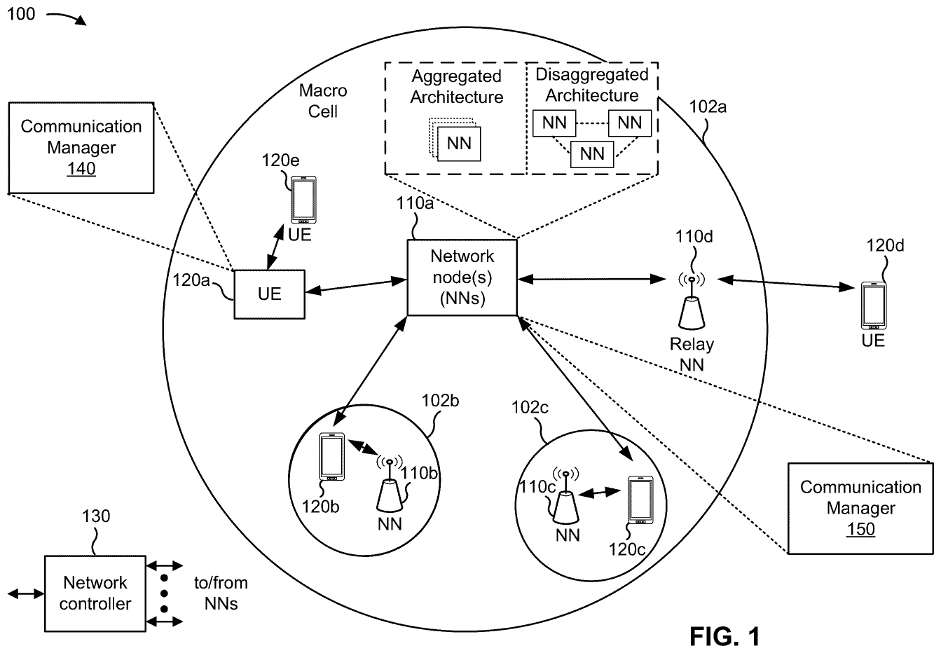

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a configuration of cell DTX or cell DRX; receive a configuration of CA associated with a Pcell and an Scell; receive an indication to activate or deactivate the cell DTX or cell DRX for the Pcell; and skip, or monitor for, based at least in part on the indication to activate or deactivate the cell DTX or cell DRX for the Pcell, reception or transmission of one or more channels associated with the Scell. Additionally, or alternatively, the communication manager 140 may perform one or more other operations described herein.

In some aspects, the network node 110 may include a communication manager 150. As described in more detail elsewhere herein, the communication manager 150 may transmit a configuration of cell DTX or cell DRX; transmit a configuration of CA associated with a Pcell and an Scell; transmit an indication to activate or deactivate the cell DTX or cell DRX for the Pcell; and skip reception or transmission of, or transmit, based at least in part on the indication to activate or deactivate the cell DTX or cell DRX for the Pcell, one or more channels associated with the Scell. Additionally, or alternatively, the communication manager 150 may perform one or more other operations described herein.

As indicated above, FIG. 1 is provided as an example. Other examples may differ from what is described with regard to FIG. 1.

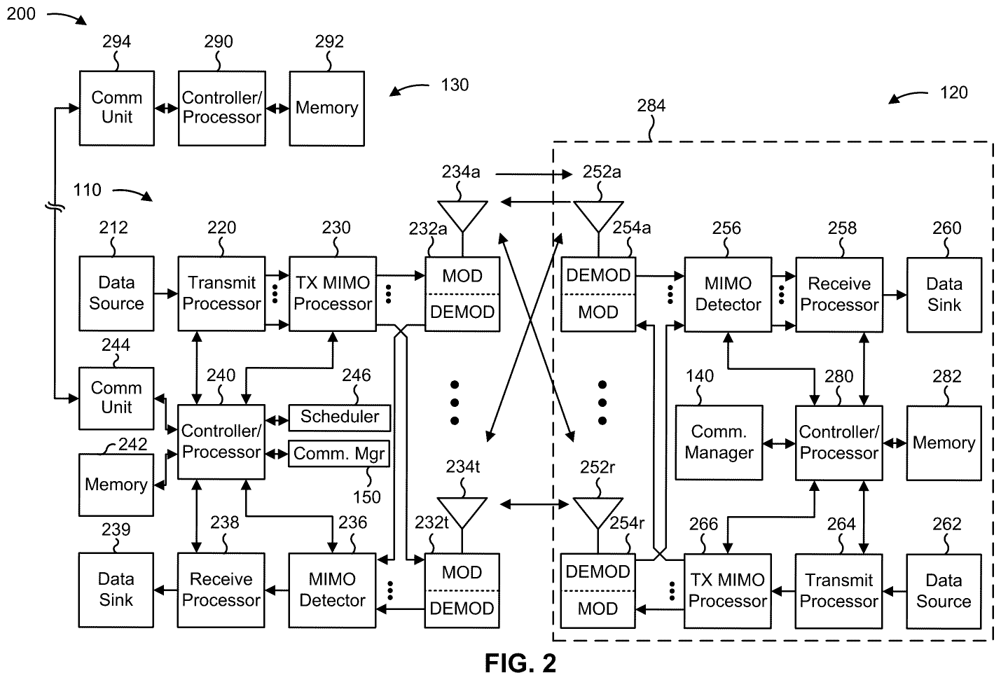

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

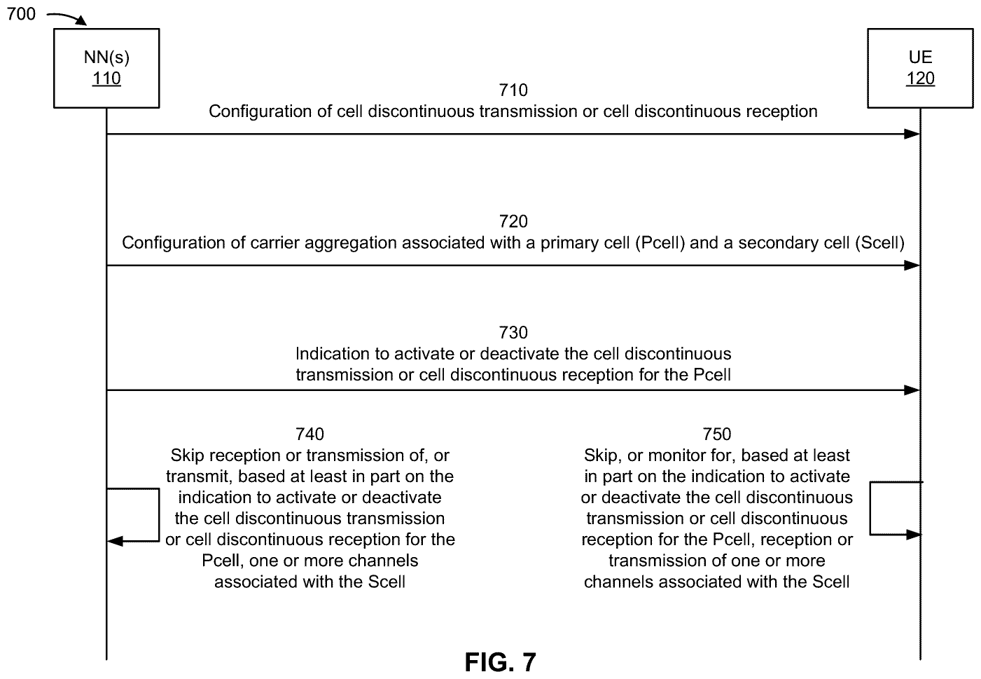

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-12).

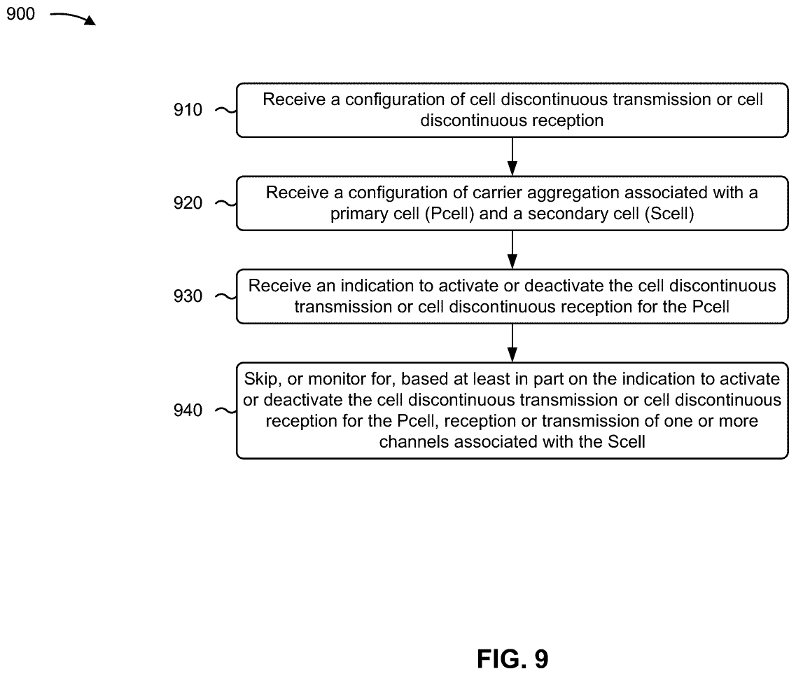

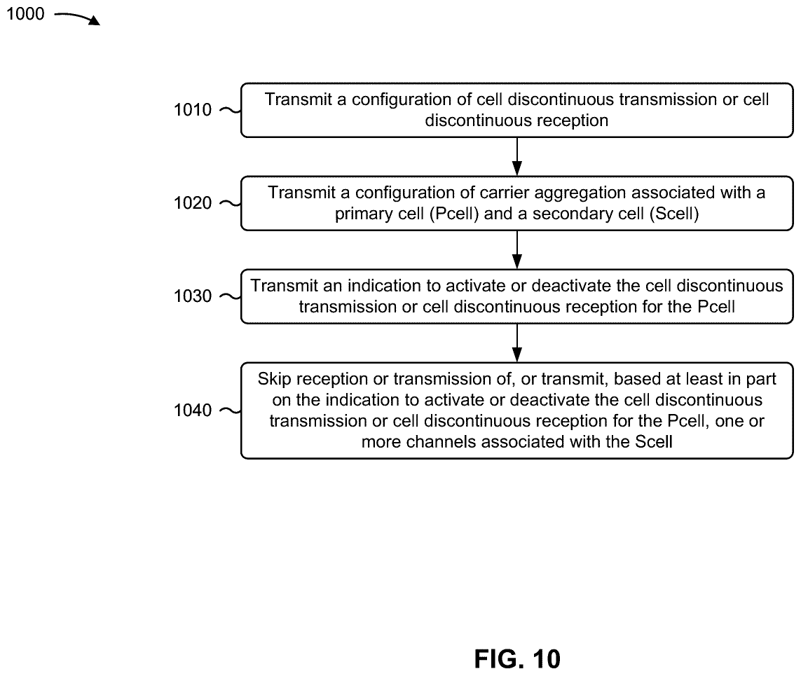

The controller/processor 240 of the network node 110, the controller/processor 280 of the UE 120, and/or any other component(s) of FIG. 2 may perform one or more techniques associated with cell DTX or cell DRX with CA, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for receiving a configuration of cell DTX or cell DRX; means for receiving a configuration of CA associated with a Pcell and an Scell; means for receiving an indication to activate or deactivate the cell DTX or cell DRX for the Pcell; and/or means for skipping, or monitoring for, based at least in part on the indication to activate or deactivate the cell DTX or cell DRX for the Pcell, reception or transmission of one or more channels associated with the Scell. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting a configuration of cell DTX or cell DRX; means for transmitting a configuration of CA associated with a Pcell and an Scell; means for transmitting an indication to activate or deactivate the cell discontinuous transmission or cell discontinuous reception for the Pcell; and/or means for skipping reception or transmission of, or transmitting, based at least in part on the indication to activate or deactivate the cell DTX or cell DRX for the Pcell, one or more channels associated with the Scell. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

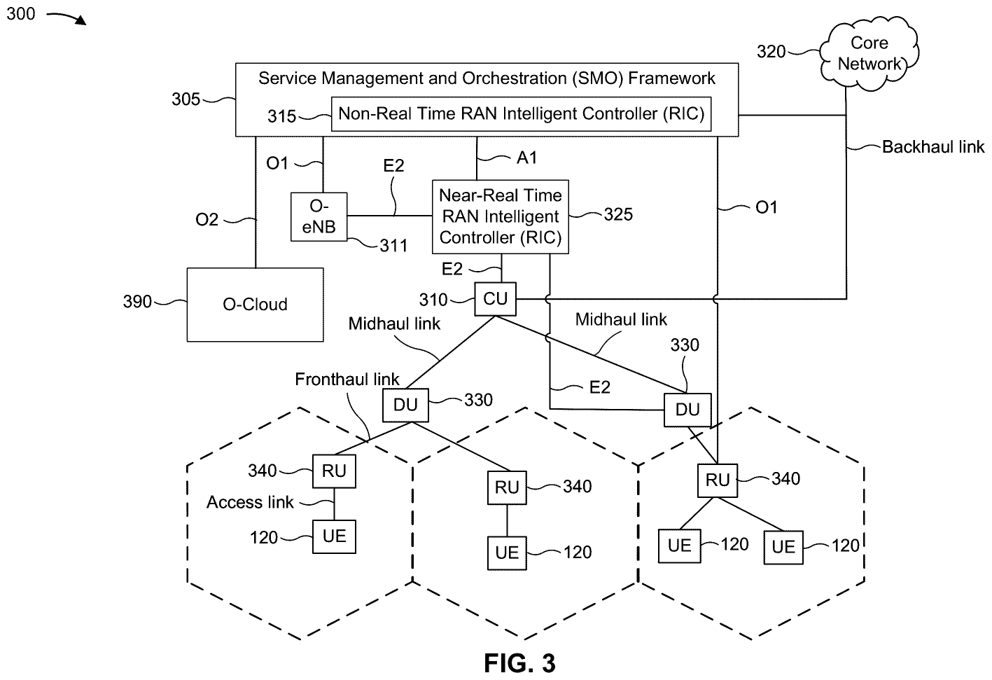

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-cNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-cNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

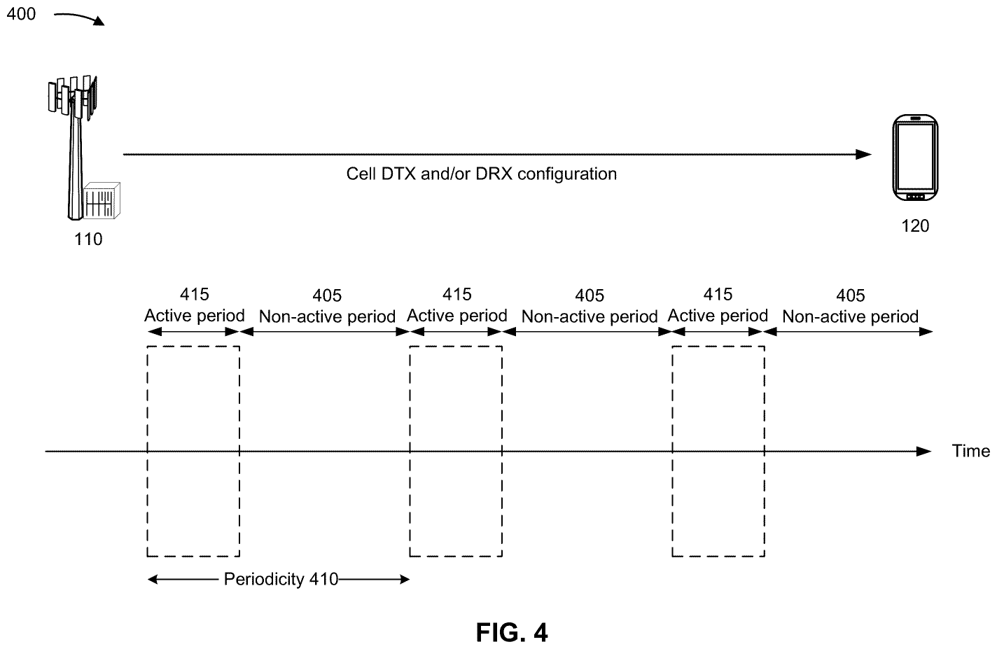

FIG. 4 is a diagram illustrating an example 400 of cell DTX and/or DRX, in accordance with the present disclosure. As shown in FIG. 4, example 400 includes a UE 120 in communication with a network node 110. In some examples, the UE 120 may be in a connected state (e.g., an RRC connected state) with the network node 110.

As shown, the network node 110 may transmit a cell DTX and/or DRX configuration to the UE 120 to configure a cell DTX and/or DRX cycle for the UE 120. For example, the configuration may be for cell DTX, cell DRX, or both cell DTX and cell DRX. The configuration may be common for UEs in the cell, and may be configured via UE-specific RRC signaling. A configuration for cell DTX may be the same as, or different from, a configuration for cell DRX.

The configuration may indicate a non-active period 405 (which may also be referred to as an “uplink and/or downlink channel restriction window”) for the cycle. The configuration may indicate a periodicity 410 of the cycle, a start slot or offset of the cycle, or a duration of an active period 415 of the cycle, among other examples.

One or more types of physical channels or signals may be restricted during the non-active period 405 (e.g., a restricted channel or signal that is scheduled or configured during the non-active period 405 may be dropped by the network node 110 and/or the UE 120). That is, the UE 120 may be expected to not transmit or receive particular channels or signals during the non-active period 405. In this way, the network node 110 may enter a sleep state during the non-active period 405.

Downlink channels or signals restricted during the non-active period 405 may include periodic and/or semi-persistent channel state information reference signals (CSI-RSs) (e.g., including tracking reference signals (TRSs)), positioning reference signals (PRSs), PDCCHs scrambled with a UE-specific radio network temporary identifier (RNTI), PDCCHs in a type-3 common search space (CSS) (e.g., a group-common PDCCH), and/or semi-persistent scheduling (SPS) physical downlink shared channels (PDSCHs), among other examples. Additionally, or alternatively, uplink channels or signals restricted during the non-active period 405 may include scheduling requests, periodic and/or semi-persistent channel state information (CSI) reports, periodic and/or semi-persistent sounding reference signals (SRSs), and/or configured grant (CG) physical uplink shared channels (PUSCHs), among other examples.

The active periods 415 may be outside of (e.g., between) non-active periods 405. Physical channel or signal restrictions applicable to the non-active period 405 may not be applicable to the active period 415.

In some examples, during the non-active period 405, the UE 120 may be expected to drop physical channels or signals associated with a minimal impact to UE implementation complexity or system performance. For example, in downlink, the UE 120 may drop reception of a PDCCH in a type-3 CSS, an SPS communication, a CSI-RS for generating CSI, and/or a CSI-RS for propagation delay compensation, among other examples. Additionally, or alternatively, in uplink, the UE 120 may drop transmission of a scheduling request, a CG communication, and/or CSI feedback, among other examples. However, during the non-active period 405, the UE 120 may not be expected to drop physical channels or signals associated with a high impact to UE implementation complexity or system performance. For example, in downlink, the UE 120 may receive a CSI-RS for tracking (e.g., a TRS), a CSI-RS for positioning, a CSI-RS for beam management, and/or a CSI-RS for beam failure detection, among other examples. Additionally, or alternatively, in uplink, the UE 120 may transmit an SRS for positioning and/or a scheduling request, among other examples.

Accordingly, the network node may sometimes be awake during non-active periods 405 to transmit and/or receive communications associated with the physical channels or signals that have significant impact on system and UE performance, thereby impacting network energy savings. For example, from a network energy savings perspective, dropping all types of channels or signals during the non-active period 405 may be ideal. However, doing so may have an adverse effect on system and UE performance.

The terms “active period,” “active time,” “active duration,” and “on duration” may be used interchangeably with respect to cell DTX/DRX. The terms “non-active period,” “non-active time,” “non-active duration,” “inactive period,” “inactive time,” “inactive duration,” and “off duration” may be used interchangeably with respect to cell DTX/DRX.

As indicated above, FIG. 4 is provided as an example. Other examples may differ from what is described with respect to FIG. 4.

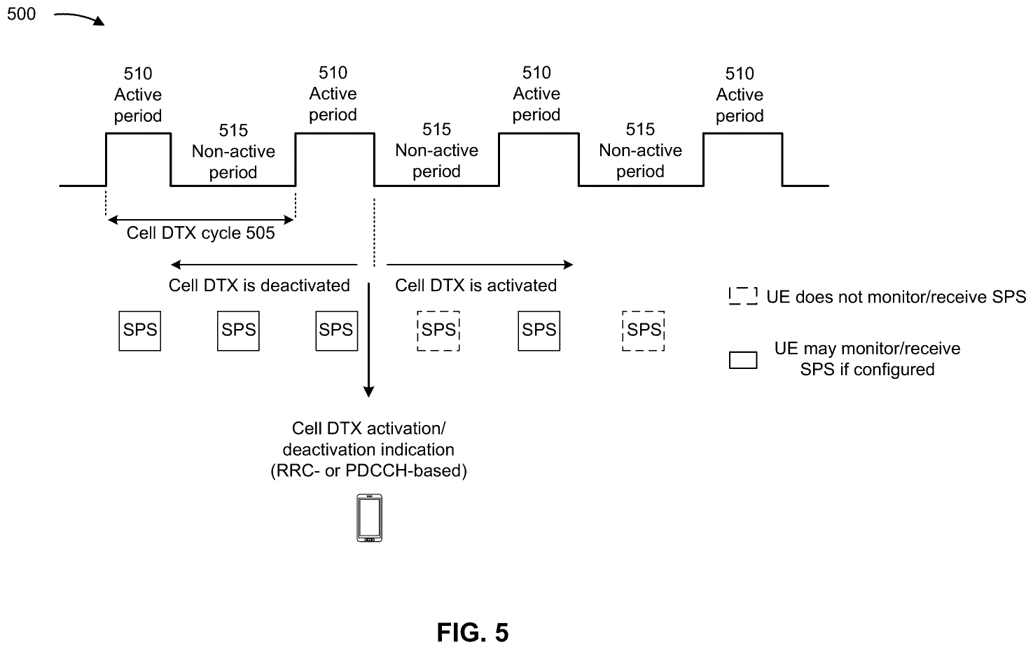

FIG. 5 is a diagram illustrating an example 500 of cell DTX cycle activation or deactivation, in accordance with the present disclosure. As shown, a cell DTX cycle 505 may include alternating active periods 510 and non-active periods 515. In some examples, the cell DTX cycle 505 may include one active period 510 and non-active period 515 and may repeat. A UE may be configured to monitor a downlink channel during the active period 510, and to refrain from monitoring the downlink channel during the non-active period 515. In some examples, a network node may be configured to enter a sleep state during the non-active periods 515. For example, the network node may be configured to refrain from transmitting communications during the non-active periods 515.

In example 500, the network node may be configured to transmit, and the UE may be configured to receive, a periodic SPS downlink transmission. For example, one SPS downlink transmission may be scheduled during each active period 510 and one SPS downlink transmission may be scheduled during each non-active period 515. As shown, while cell DTX is deactivated, the UE receives at least one SPS

PDSCH/PDCCH transmission during an non-active period 515. The network node may wake up (or remain awake) during the non-active period 515, which may enable the network node to transmit the SPS downlink transmission during the non-active period 515. The UE may wake up (or remain awake) during the non-active period 515, which may enable the UE to monitor for and receive the SPS downlink transmission during the non-active period 515. As a result, the network node and the UE may consume more power during the non-active periods 515 when cell DTX is deactivated than the network node and the UE would consume during the non-active periods 515 when cell DTX is activated.

As shown, the network node may output, and the UE may receive, a cell DTX activation/deactivation indication. In this example, the cell DTX activation/deactivation indication may cause the UE to activate cell DTX. For example, when cell DTX is activated, the network node may skip transmission, and the UE may skip reception, of one or more channels during a non-active period 515. For example, the network node may refrain from transmitting, and the UE may refrain from monitoring for or receiving, the SPS downlink transmissions during one or more non-active periods 515 that occur when cell DTX is activated. For example, one or more SPS transmissions may be restricted. As shown, the UE may refrain from monitoring for or receiving, and the network node may refrain from transmitting, the SPS downlink transmissions during non-active periods 515 when cell DTX is activated. As a result, during non-active periods 515 when cell DTX is activated, the network node and the UE may persist in sleep states and/or consume less power than the network node and the UE would consume during the non-active periods 515 when cell DTX is deactivated.

As indicated above, FIG. 5 is provided as an example. Other examples may differ from what is described with respect to FIG. 5.

Cell DTX/DRX may be activated and/or deactivated via RRC, MAC control element (MAC-CE), DCI, or the like. For example, cell DTX/DRX may be activated and/or deactivated via RRC signaling explicitly or implicitly. For example, the RRC signaling may explicitly include at least bits for cell DTX/DRX activation/deactivation (e.g., one bit for cell DTX activation/deactivation and one bit for cell DRX activation/deactivation). The RRC signaling may implicitly indicate that the cell DTX is active by configuring the cell DTX/DRX, and the RRC signaling may implicitly indicate that the cell DTX is deactivated by including another RRC message that does not include the cell DTX/DRX configuration. For example, cell DTX/DRX may be activated immediately once configured via RRC and deactivated once the RRC configuration is released.

Furthermore, DCI (e.g., layer 1 (L1) signaling, PDCCH-based signaling, or the like) may be used to disable or enable cell DTX/DRX operation. For example, L1 signaling may be used to disable or enable cell DTX/DRX operation based on a current load of the cell. For example, L1 signaling may be used to enable cell DTX/DRX operation when the cell has no or a few connected mode UEs (e.g., low/medium cell loading) and/or disable cell DTX/DRX operation when the cell has many connected mode UEs (e.g., high cell loading).

The L1 signaling may include group-common DCI carried by PDCCH. The content of the DCI may include at least bits for cell DTX/DRX activation/deactivation (e.g., one bit for cell DTX activation/deactivation and one bit for cell DRX activation/deactivation). The UE may experience application delay from the time the UE receives the L1 signaling to the time the cell DTX/DRX starts.

When cell DTX/DRX is activated, the network node may not transmit certain physical channels/signals during the non-active period of the cell DTX and/or may not receive certain physical channels/signals during the non-active period/period of cell DRX, which may enable the network node to sleep and thereby achieve network power savings. Physical channels or signals that support RRC idle/inactive mode UEs may not be dropped during the non-active period of cell DTX or during the non-active period of cell DRX. As a result, the UE may continue to receive or transmit these signals/channels during the non-active period if needed. Examples of such channel/signals that are not impacted by cell DTX/DRX may include synchronization signal block (SSB), PDCCH/PDSCH for paging, PDCCH/PDSCH for system information, random access channel (RACH)-related channels, or the like.

However, UE may not receive or monitor certain physical channels/signals during the non-active period of cell DTX and/or may not transmit certain physical channels/signals during the non-active period of cell DRX. Examples of such channel/signals that are impacted by cell DTX/DRX may include uplink channels/signals (e.g., configured grant PUSCH, physical uplink control channel (PUCCH) carrying a CSI report, PUSCH carrying a CSI report, scheduling request (SR), SRS, or the like) and/or downlink channels/signals (e.g., SPS, periodic/semi-persistent CSI-RS for CSI report, UE-specific PDCCH, or the like).

Cell DTX/DRX and UE DRX may be aligned for RRC connected mode. Inter-node information relating to cell DTX/DRX may be exchanged. Cell DTX/DRX may not impact SSB transmission or idle/inactive UEs.

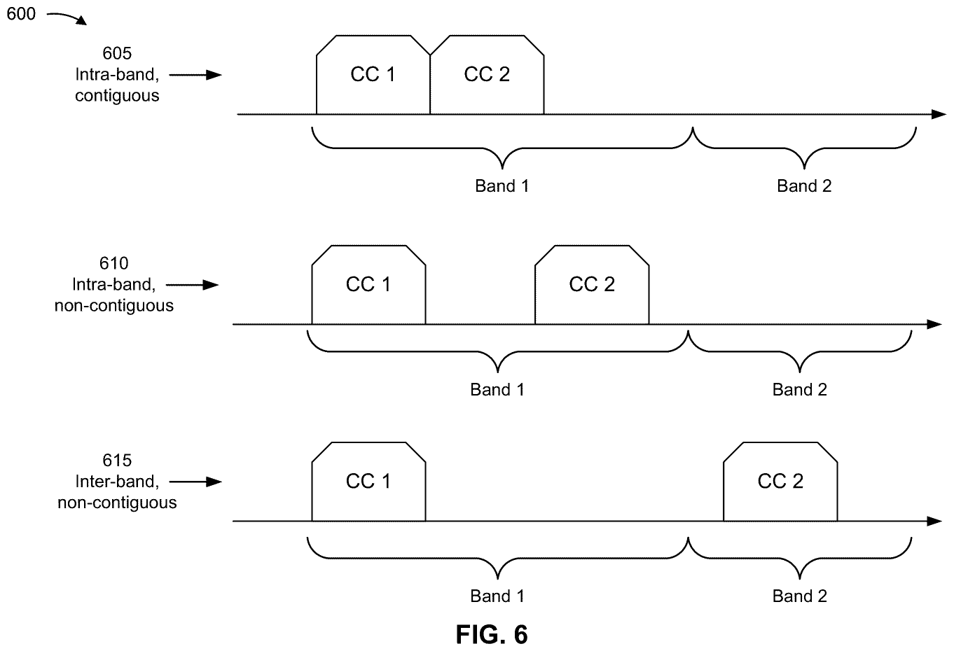

FIG. 6 is a diagram illustrating examples 600 of CA, in accordance with the present disclosure.

CA is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A network node 110 may configure carrier aggregation for a UE 120, such as in a RRC message, DCI, and/or another signaling message.

As shown by reference number 605, in some aspects, carrier aggregation may be configured in an intra-band contiguous mode where the aggregated carriers are contiguous to one another and are in the same band. As shown by reference number 610, in some aspects, carrier aggregation may be configured in an intra-band non-contiguous mode where the aggregated carriers are non-contiguous to one another and are in the same band. As shown by reference number 615, in some aspects, carrier aggregation may be configured in an inter-band non-contiguous mode where the aggregated carriers are non-contiguous to one another and are in different bands.

In carrier aggregation, a UE 120 may be configured with a primary carrier or Pcell and one or more secondary carriers or Scells. In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling. For example, a Pcell may include a serving cell on which RRC signaling messages are exchanged, or on which the PUCCH is transmitted, and an Scell may include a serving cell that is configured via RRC signaling on the Pcell.

In CA, the network node may activate/deactivate one or more Scells via RRC. For example, the network node may activate or deactivate one or more Scells based on resource utilization (e.g., network load). For example, the network node may deactivate one or more Scells in response to a decrease in network load, which may achieve network energy savings.

As indicated above, FIG. 6 is provided as an example. Other examples may differ from what is described with regard to FIG. 6.

Cell DTX/DRX, which may be used for network energy savings, is supported for both single carrier and CA scenarios. For example, cell DTX/DRX can be applied to CA. As a result, the UE may support both cell DTX/DRX and CA simultaneously, which can impact UE processing, especially when the cell DTX/DRX patterns across Scells are not aligned. For example, a network node may turn off one or more Scells when network energy savings is needed, and turn on one or more Scells when network energy savings is not needed, via a Scell activation/deactivation procedure (e.g., instead of applying cell DTX/DRX). However, being RRC-based, Scell activation/deactivation may be associated with a latency that can lead to inefficiencies. For example, because DCI is generally associated with lower latency than RRC, RRC-based Scell activation/deactivation may lag behind DCI-based cell DTX/DRX activation/deactivation. For instance, this latency can cause the Scells to remain activated for some time after the cell DTX/DRX is activated, which can consume energy.

FIG. 7 is a diagram illustrating an example 700 associated with cell DTX/DRX with CA, in accordance with the present disclosure. As shown in FIG. 7, a network node 110 and a UE 120 may communicate with one another.

As shown by reference number 710, the network node 110 transmits, and the UE 120 receives, a configuration of cell DTX or cell DRX. As shown by reference number 720, the network node 110 transmits, and the UE 120 receives, a configuration of CA associated with a Pcell and an Scell. For example, the configuration of CA may configure the UE 120 with the Pcell and the Scell. As a result, the UE 120 be configured with both CA operation and cell DTX/DRX operation.

As shown by reference number 730, the network node 110 transmits, and the UE 120 receives, an indication to activate or deactivate the cell DTX or cell DRX for the Pcell. For example, the indication may activate the cell DTX or the cell DRX (e.g., in a case where the cell DTX or the cell DRX is currently deactivated), or the indication may deactivate the cell DTX or the cell DRX (e.g., in a case where the cell DTX or the cell DRX is currently activated).

As shown by reference number 740, the network node 110 may skip reception or transmission of, or transmit, based at least in part on the indication to activate or deactivate the cell discontinuous transmission or cell discontinuous reception for the Pcell, one or more channels (e.g., PHY channels) associated with the Scell. In some examples, the one or more channels associated with the Scell may be one or more channels that are transmitted via the Scell (or would, if transmitted, be transmitted via the Scell).

For example, in a case where the network node 110 transmits an indication to activate the cell DTX or cell DRX for the Pcell, the network node 110 may skip, based at least in part on the indication to activate the cell DTX or cell DRX for the Pcell, the reception or transmission of the one or more channels associated with the Scell. The network node 110 may skip the reception or transmission of the one or more channels associated with the Scell regardless of whether cell DTX/DRX is activated for the Scell. In a case where the network node 110 transmits an indication to deactivate the cell DTX or cell DRX for the Pcell, the network node 110 may transmit, based at least in part on the indication to activate the cell DTX or cell DRX for the Pcell, the one or more channels associated with the Scell.

As shown by reference number 750, the UE 120 may skip, or monitor for (and/or perform), based at least in part on the indication to activate or deactivate the cell discontinuous transmission or cell discontinuous reception for the Pcell, reception or transmission of one or more channels (e.g., PHY channels) associated with the Scell. In some examples, the one or more channels associated with the Scell may be one or more channels that are transmitted via the Scell (or would, if transmitted, be transmitted via the Scell).

For example, in a case where the UE 120 receives an indication to activate the cell DTX or cell DRX for the Pcell, the UE 120 may skip, based at least in part on the indication to activate the cell DTX or cell DRX for the Pcell, the reception or transmission of the one or more channels associated with the Scell. The UE 120 may skip the reception or transmission of the one or more channels associated with the Scell regardless of whether cell DTX/DRX is activated for the Scell.

In some aspects, the network node 110 may skip the reception or transmission of the one or more channels associated with the Scell by refraining from transmitting a PDCCH associated with the Scell, and the UE 120 may skip the reception or transmission of the one or more channels associated with the Scell by refraining from monitoring the PDCCH associated with the Scell. For example, the UE 120 may not monitor the PDCCH in the Scell based at least in part on the indication to activate the cell DTX or cell DRX for the Pcell. For example, the UE 120 may not monitor the PDCCH that contains a cell DTX/DRX activation/deactivation indication, if transmitted. The UE 120 may perform functions other than PDCCH monitoring according to the cell DTX/DRX activation/deactivation status of the Scell.

In some aspects, the network node 110 and the UE 120 may skip the reception or transmission of the one or more channels associated with the Scell based at least in part on cell DTX or cell DRX for the Scell. For example, the UE 120 may treat the activation of the cell DTX/DRX for the Pcell as an activation of a cell DTX/DRX at the Scell.

In some aspects, the network node 110 may skip the reception or transmission of the one or more channels associated with the Scell by refraining from transmitting a PDCCH associated with the Scell, the UE 120 may skip the reception or transmission of the one or more channels associated with the Scell by refraining from monitoring the PDCCH associated with the Scell, and network node 110 and the UE 120 may further skip the reception or transmission of the one or more channels associated with the Scell by refraining from monitoring for or transmitting scheduled uplink or downlink data associated with the Scell. For example, the UE 120 may treat the treat the activation of the cell DTX/DRX for the Pcell as an indication that the Scell is to transition to a dormant state with no PDCCH monitoring or scheduled uplink/downlink data (e.g., scheduled uplink or downlink data that is scheduled via cross-carrier scheduling). In some examples, the network node 110 and the UE 120 may exchange CSI and/or beam measurement (BM) measurements/reports on the Scell when cell DTX/DRX is activated on the Pcell.

In a further aspect, the network node 110 may skip the reception or transmission of the one or more channels associated with the Scell by refraining from transmitting CSI-RSs (e.g., for BM and/or CSI) associated with the Scell and with one or more of BM or CSI, and the UE 120 may skip the reception or transmission of the one or more channels associated with the Scell by refraining from monitoring for CSI-RSs associated with the Scell and with one or more of BM or CSI. Moreover, the UE 120 may further skip the reception or transmission of the one or more channels associated with the Scell further by refraining from transmitting a CSI report, and the network node 110 may skip the reception or transmission of the one or more channels associated with the Scell by refraining from monitoring for a CSI report. For example, the UE may operate as though no CSI-RS for the BM and/or the CSI is transmitted from the Scell, and UE may not transmit a CSI report.

In some aspects, the network node 110 may transmit, and the UE 120 may receive, an indication of one or more Scells including the Scell. The network node 110 may skip the reception or transmission of, or transmit, the one or more channels associated with the Scell based at least in part on the indication of the one or more Scells. The UE 120 may skip, or monitor for, the reception or transmission of the one or more channels associated with the Scell based at least in part on the indication of the one or more Scells. For example, the indication of the one or more Scells may be a list of Scells. The list may indicate that the UE 120 is to skip, or monitor for (and/or perform), reception or transmission of one or more channels associated with the Scells. The indication of the one or more Scells may be transmitted via RRC (which may also be used to indicate the cell DTX/DRX configuration and/or the CA configuration, including Scell activation) or in DCI (which may also provide the indication of cell DTX/DRX activation/deactivation).

In a case where the UE 120 receives an indication to deactivate the cell DTX or cell DRX for the Pcell, the UE 120 may monitor for, based at least in part on the indication to deactivate the cell DTX or cell DRX for the Pcell, the one or more channels associated with the Scell. In some aspects, the network node 110 may transmit, and the UE 120 may monitor, a PDCCH associated with the Scell based at least in part on the indication to deactivate the cell DTX or cell DRX for the Pcell. For example, if the cell DTX/DRX is deactivated for the Pcell, the UE 120 may monitor the PDCCH containing the cell DTX/DRX activation/deactivation indication, if transmitted in the Scell. The UE 120 may further act based on (e.g., follow) a cell DTX activation/deactivation indication for the Scell.

Further provided herein are aspects relating to a time at which the UE 120 begins skipping, or monitoring for, the reception or transmission of the one or more channels associated with the Scell. These aspects may define a timeline that governs when the skipping or monitoring starts. In any case, there may be some application delay from the time the UE 120 receives the cell DTX/DRX activation/deactivation indication (e.g., command) to the time that the cell DTX/DRX is actually activated/deactivated.

In some aspects, in a case where the UE 120 receives an indication to activate the cell DTX or cell DRX for the Pcell, the UE 120 may skip the reception or transmission of the one or more channels associated with the Scell beginning at a first time at which the cell discontinuous transmission or cell discontinuous reception for the Pcell is activated or at a second time that is offset from the first time. In some examples, if cell DTX/DRX is activated at the Pcell, the UE 120 may skip the reception or transmission of the one or more channels associated with the Scell starting from the first time (e.g., the same time that the cell DTX/DRX is activated at the Pcell). In some examples, if cell DTX/DRX is activated at the Pcell, the UE 120 may skip the reception or transmission of the one or more channels associated with the Scell starting from the second time (e.g., a time that is offset from the time that the cell DTX/DRX is activated at the Pcell).

In the case where the UE 120 skips the reception or transmission of the one or more channels associated with the Scell based at least in part on the cell DTX or cell DRX for the Scell, the UE 120 may skip the reception or transmission of the one or more channels associated with the Scell beginning at a start time of a non-active period of the cell DTX or cell DRX for the Scell. For example, start time may occur after the cell DTX or cell DRX for the Pcell is activated. For example, the UE 120 may start skipping the reception or transmission of the one or more channels on the Scell from a non-active time of the cell DTX/DRX at the Scell that occurs after the time that the cell DTX/DRX starts at the Pcell.

In some aspects, in a case where the UE 120 receives an indication to deactivate the cell DTX or cell DRX for the Pcell, the UE 120 may monitor a PDCCH associated with the Scell beginning at a first time at which the cell DTX or cell DRX for the Pcell is deactivated or at a second time that is offset from the first time. In some examples, if cell DTX/DRX is deactivated at the Pcell, then the UE 120 may start monitoring the PDCCH from the first time (e.g., the same time that the cell DTX/DRX is deactivated at the Pcell). In some examples, if cell DTX/DRX is deactivated at the Pcell, then the UE 120 may monitor the PDCCH starting from the second time (e.g., a time that is offset from the time that the cell DTX/DRX is activated at the Pcell).

In the case where the UE 120 skips the reception or transmission of the one or more channels associated with the Scell based at least in part on the cell DTX or cell DRX for the Scell, the UE 120 may receive an indication to deactivate the cell DTX or cell DRX for the Pcell. The UE 120 may monitor, based at least in part on the indication to deactivate the cell DTX or cell DRX for the Pcell, a PDCCH associated with the Scell beginning at a start time of an active period of the cell DTX or cell DRX for the Scell. The start time may occur after the cell DTX or cell DRX for the Pcell is deactivated. For example, the UE 120 may starts monitor the PDCCH on the Scell from an active time of cell DTX/DRX at the Scell that occurs after the time that the cell DTX/DRX is deactivated at the Pcell.

The network node 110 skipping reception or transmission of, or transmitting, based at least in part on the indication to activate or deactivate the cell DTX or cell DRX for the Pcell, one or more channels associated with the Scell, and the UE 120 skipping, or monitoring for, reception or transmission of one or more channels associated with the Scell based at least in part on the indication to activate or deactivate the cell DTX or cell DRX for the Pcell, may avoid RRC-based Scell activation/deactivation while supporting cell DTX/DRX. For example, the skipping, monitoring, and/or transmission may be based on the cell DTX or cell DRX activation/deactivation indication for the Pcell (e.g., rather than an RRC-based Scell activation/deactivation indication). Therefore, the latency caused by RRC-based Scell activation/deactivation may be reduced or eliminated. Allowing both CA and cell DTX/DRX to be supported simultaneously while impose certain restrictions on Scells, as described above, may enable fast Scell activation/deactivation and thereby reduce power consumption (e.g., UE power consumption).

Refraining from monitoring or transmitting a PDCCH associated with the Scell may mimic deactivation of the Scell, thereby enabling the UE to reduce power consumption (e.g., over both active and non-active periods). Skipping the reception or transmission of the one or more channels associated with the Scell based at least in part on cell discontinuous transmission or cell discontinuous reception for the Scell may enable the UE 120 to use the Scell while providing network energy savings to the network node 110. Refraining from monitoring or transmitting a PDCCH associated with the Scell and refraining from monitoring for or transmitting scheduled uplink or downlink data associated with the Scell may confer energy savings to the network node 110 and the UE 120, which may each avoid monitoring for and/or transmitting PDCCH and/or scheduled uplink or downlink data.

As indicated above, FIG. 7 is provided as an example. Other examples may differ from what is described with respect to FIG. 7.

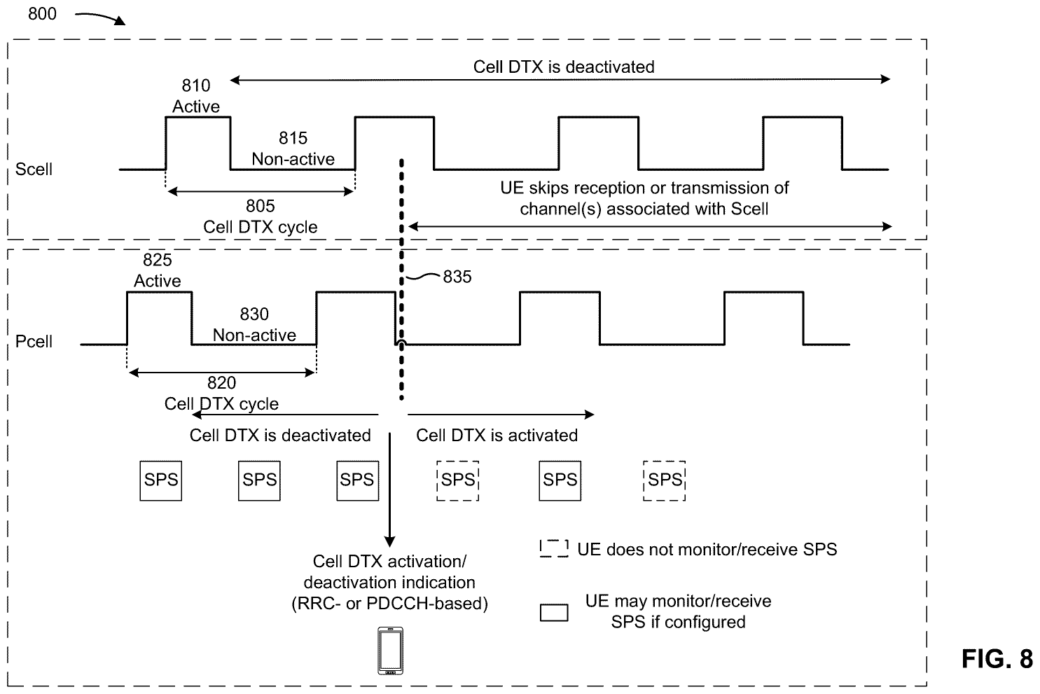

FIG. 8 is a diagram illustrating an example 800 associated with skipping reception or transmission of one or more channels associated with an Scell beginning at when a cell DTX for a Pcell is activated, in accordance with the present disclosure.

In example 800, cell DTX may be configured for an Scell and a Pcell. The cell DTX configuration for the Scell may include a cell DTX cycle 805 that includes alternating active periods 810 and non-active periods 815. The cell DTX configuration for the Pcell may include a cell DTX cycle 820 that includes alternating active periods 825 and non-active periods 830.

In example 800, the cell DTX for the Scell is deactivated. The cell DTX for the Pcell is initially deactivated, and is activated, at time 835, after a UE receives an indication to activate the cell DTX for the Pcell. At the time 835 (e.g., when the cell DTX for the Pcell is activated), the UE also begins skipping reception or transmission of one or more channels associated with an Scell (e.g., regardless of the cell DTX configuration of the Scell).

As indicated above, FIG. 8 is provided as an example. Other examples may differ from what is described with respect to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with cell DTX or cell DRX with CA.

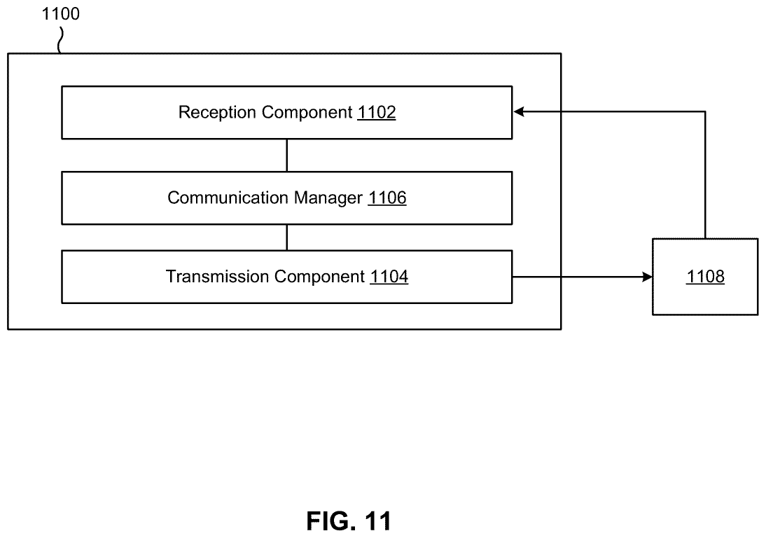

As shown in FIG. 9, in some aspects, process 900 may include receiving a configuration of cell DTX or cell DRX (block 910). For example, the UE (e.g., using reception component 1102 and/or communication manager 1106, depicted in FIG. 11) may receive a configuration of cell DTX or cell DRX, as described above.

As further shown in FIG. 9, in some aspects, process 900 may include receiving a configuration of CA associated with a Pcell and an Scell (block 920). For example, the UE (e.g., using reception component 1102 and/or communication manager 1106, depicted in FIG. 11) may receive a configuration of CA associated with a Pcell and an Scell, as described above.

As further shown in FIG. 9, in some aspects, process 900 may include receiving an indication to activate or deactivate the cell DTX or cell DRX for the Pcell (block 930). For example, the UE (e.g., using reception component 1102 and/or communication manager 1106, depicted in FIG. 11) may receive an indication to activate or deactivate the cell DTX or cell DRX for the Pcell, as described above.

As further shown in FIG. 9, in some aspects, process 900 may include skipping, or monitoring for, based at least in part on the indication to activate or deactivate the cell DTX or cell DRX for the Pcell, reception or transmission of one or more channels associated with the Scell (block 940). For example, the UE (e.g., using communication manager 1106, depicted in FIG. 11) may skip, or monitor for, based at least in part on the indication to activate or deactivate the cell DTX or cell DRX for the Pcell, reception or transmission of one or more channels associated with the Scell, as described above.

Process 900 may include additional aspects, such as any single aspect or any combination of aspects described below and/or in connection with one or more other processes described elsewhere herein.

In a first aspect, receiving the indication to activate or deactivate the cell DTX or cell DRX for the Pcell includes receiving an indication to activate the cell DTX or cell DRX for the Pcell, and skipping, or monitoring for, the reception or transmission of the one or more channels associated with the Scell includes skipping, based at least in part on the indication to activate the cell DTX or cell DRX for the Pcell, the reception or transmission of the one or more channels associated with the Scell.

In a second aspect, alone or in combination with the first aspect, skipping the reception or transmission of the one or more channels associated with the Scell includes refraining from monitoring a PDCCH associated with the Scell.

In a third aspect, alone or in combination with one or more of the first and second aspects, skipping the reception or transmission of the one or more channels associated with the Scell includes skipping the reception or transmission of the one or more channels associated with the Scell based at least in part on cell discontinuous transmission or cell discontinuous reception for the Scell.

In a fourth aspect, alone or in combination with one or more of the first through third aspects, skipping the reception or transmission of the one or more channels associated with the Scell includes skipping the reception or transmission of the one or more channels associated with the Scell beginning at a start time of a non-active period of the cell discontinuous transmission or cell discontinuous reception for the Scell, and the start time occurs after the cell discontinuous transmission or cell discontinuous reception for the Pcell is activated.

In a fifth aspect, alone or in combination with one or more of the first through fourth aspects, process 900 includes receiving an indication to deactivate the cell DTX or cell DRX for the Pcell, and monitoring, based at least in part on the indication to deactivate the cell DTX or cell DRX for the Pcell, a PDCCH associated with the Scell beginning at a start time of an active period of the cell discontinuous transmission or cell discontinuous reception for the Scell, and the start time occurs after the cell DTX or cell DRX for the Pcell is deactivated.

In a sixth aspect, alone or in combination with one or more of the first through fifth aspects, skipping the reception or transmission of the one or more channels associated with the Scell includes refraining from monitoring a PDCCH associated with the Scell and refraining from monitoring for or transmitting scheduled uplink or downlink data associated with the Scell.

In a seventh aspect, alone or in combination with one or more of the first through sixth aspects, skipping the reception or transmission of the one or more channels associated with the Scell further includes refraining from monitoring for CSI-RSs associated with the Scell and with one or more of BM or CSI, and skipping the reception or transmission of the one or more channels associated with the Scell further includes refraining from transmitting a CSI report.

In an eighth aspect, alone or in combination with one or more of the first through seventh aspects, skipping the reception or transmission of the one or more channels associated with the Scell includes skipping the reception or transmission of the one or more channels associated with the Scell beginning at a first time at which the cell DTX or cell DRX for the Pcell is activated or at a second time that is offset from the first time.

In a ninth aspect, alone or in combination with one or more of the first through eighth aspects, process 900 includes receiving an indication of one or more Scells including the Scell, and skipping, or monitoring for, the reception or transmission of the one or more channels includes skipping, or monitoring for, the reception or transmission of the one or more channels associated with the Scell based at least in part on the indication of the one or more Scells.

In a tenth aspect, alone or in combination with one or more of the first through ninth aspects, skipping, or monitoring for, the reception or transmission of the one or more channels associated with the Scell includes monitoring for, based at least in part on the indication to deactivate the cell DTX or cell DRX for the Pcell, the reception or transmission of the one or more channels associated with the Scell.

In an eleventh aspect, alone or in combination with one or more of the first through tenth aspects, monitoring for the reception or transmission of the one or more channels associated with the Scell includes monitoring a PDCCH associated with the Scell based at least in part on the indication to deactivate the cell DTX or cell DRX for the Pcell.

In a twelfth aspect, alone or in combination with one or more of the first through eleventh aspects, monitoring the PDCCH includes monitoring the PDCCH beginning at a first time at which the cell DTX or cell DRX for the Pcell is deactivated or at a second time that is offset from the first time.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with cell DTX or cell DRX with CA.

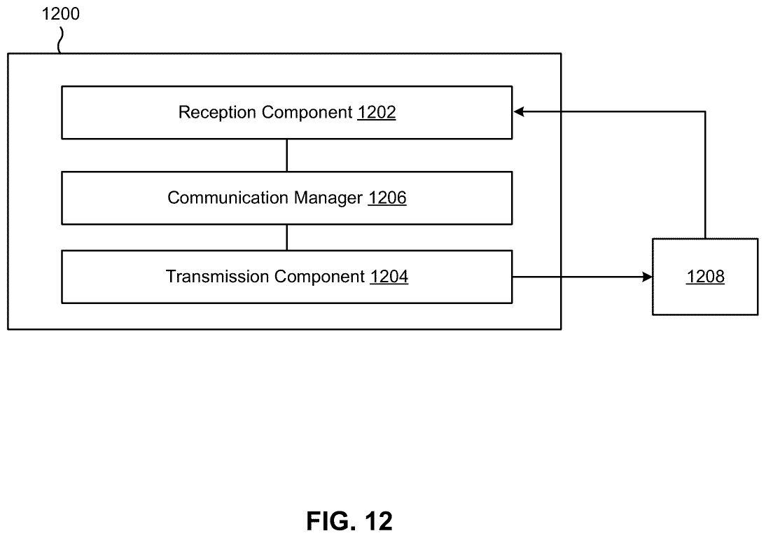

As shown in FIG. 10, in some aspects, process 1000 may include transmitting a configuration of cell DTX or cell DRX (block 1010). For example, the network node (e.g., using transmission component 1204 and/or communication manager 1206, depicted in FIG. 12) may transmit a configuration of cell DTX or cell DRX, as described above.

As further shown in FIG. 10, in some aspects, process 1000 may include transmitting a configuration of CA associated with a Pcell and an Scell (block 1020). For example, the network node (e.g., using transmission component 1204 and/or communication manager 1206, depicted in FIG. 12) may transmit a configuration of CA associated with a Pcell and an Scell, as described above.

As further shown in FIG. 10, in some aspects, process 1000 may include transmitting an indication to activate or deactivate the cell DTX or cell DRX for the Pcell (block 1030). For example, the network node (e.g., using transmission component 1204 and/or communication manager 1206, depicted in FIG. 12) may transmit an indication to activate or deactivate the cell DTX or cell DRX for the Pcell, as described above.

As further shown in FIG. 10, in some aspects, process 1000 may include skipping reception or transmission of, or transmitting, based at least in part on the indication to activate or deactivate the cell DTX or cell DRX for the Pcell, one or more channels associated with the Scell (block 1040). For example, the network node (e.g., using communication manager 1206, depicted in FIG. 12) may skip reception or transmission of, or transmit, based at least in part on the indication to activate or deactivate the cell DTX or cell DRX for the Pcell, one or more channels associated with the Scell, as described above.

Process 1000 may include additional aspects, such as any single aspect or any combination of aspects described below and/or in connection with one or more other processes described elsewhere herein.

In a first aspect, transmitting the indication to activate or deactivate the cell DTX or cell DRX for the Pcell includes transmitting an indication to activate the cell DTX or cell DRX for the Pcell, and skipping the reception or transmission of, or transmitting, the one or more channels associated with the Scell includes skipping, based at least in part on the indication to activate the cell DTX or cell DRX for the Pcell, the reception or transmission of the one or more channels associated with the Scell.

In a second aspect, alone or in combination with the first aspect, skipping the reception or transmission of the one or more channels associated with the Scell includes refraining from transmitting a PDCCH associated with the Scell.

In a third aspect, alone or in combination with one or more of the first and second aspects, skipping the reception or transmission of the one or more channels associated with the Scell includes skipping the reception or transmission of the one or more channels associated with the Scell based at least in part on cell DTX or cell DRX for the Scell.

In a fourth aspect, alone or in combination with one or more of the first through third aspects, skipping the reception or transmission of the one or more channels associated with the Scell includes refraining from transmitting a PDCCH associated with the Scell and refraining from monitoring for or transmitting scheduled uplink or downlink data associated with the Scell.

In a fifth aspect, alone or in combination with one or more of the first through fourth aspects, skipping the reception or transmission of the one or more channels associated with the Scell further includes refraining from transmitting CSI-RSs associated with the Scell and with one or more of BM or CSI, and skipping the reception or transmission of the one or more channels associated with the Scell further includes refraining from monitoring for a CSI report.

In a sixth aspect, alone or in combination with one or more of the first through fifth aspects, process 1000 includes transmitting an indication of one or more Scells including the Scell, and skipping the reception or transmission of, or transmitting, the one or more channels includes skipping the reception or transmission of, or transmitting, the one or more channels associated with the Scell based at least in part on the indication of the one or more Scells.

In a seventh aspect, alone or in combination with one or more of the first through sixth aspects, skipping the reception or transmission of, or transmitting, the one or more channels associated with the Scell includes transmitting, based at least in part on the indication to deactivate the cell DTX or cell DRX for the Pcell, the one or more channels associated with the Scell.

In an eighth aspect, alone or in combination with one or more of the first through seventh aspects, transmitting the one or more channels associated with the Scell includes transmitting a PDCCH associated with the Scell based at least in part on the indication to deactivate the cell DTX or cell DRX for the Pcell.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 7-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive a configuration of cell DTX or cell DRX. The reception component 1102 may receive a configuration of CA associated with a Pcell and an Scell. The reception component 1102 may receive an indication to activate or deactivate the cell DTX or cell DRX for the Pcell. The communication manager 1106 may skip, or monitor for, based at least in part on the indication to activate or deactivate the cell DTX or cell DRX for the Pcell, reception or transmission of one or more channels associated with the Scell.

The reception component 1102 may receive an indication to deactivate the cell DTX or cell DRX for the Pcell.

The communication manager 1106 may monitor, based at least in part on the indication to deactivate the cell DTX or cell DRX for the Pcell, a PDCCH associated with the Scell beginning at a start time of an active period of the cell DTX or cell DRX for the Scell, wherein the start time occurs after the cell DTX or cell DRX for the Pcell is deactivated.

The reception component 1102 may receive an indication of one or more Scells including the Scell, where skipping, or monitoring for, the reception or transmission of the one or more channels includes skipping, or monitoring for, the reception or transmission of the one or more channels associated with the Scell based at least in part on the indication of the one or more Scells.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 7-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit a configuration of cell DTX or cell DRX. The transmission component 1204 may transmit a configuration of CA associated with a Pcell and an Scell. The transmission component 1204 may transmit an indication to activate or deactivate the cell DTX or cell DRX for the Pcell. The communication manager 1206 may skip reception or transmission of, or transmit, based at least in part on the indication to activate or deactivate the cell DTX or cell DRX for the Pcell, one or more channels associated with the Scell.

The transmission component 1204 may transmit an indication of one or more Scells including the Scell, where skipping the reception or transmission of, or transmitting, the one or more channels includes skipping the reception or transmission of, or transmitting, the one or more channels associated with the Scell based at least in part on the indication of the one or more Scells.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a UE, comprising: receiving a configuration of cell DTX or cell DRX; receiving a configuration of CA associated with a Pcell and an Scell; receiving an indication to activate or deactivate the cell DTX or cell DRX for the Pcell; and skipping, or monitoring for, based at least in part on the indication to activate or deactivate the cell DTX or cell DRX for the Pcell, reception or transmission of one or more channels associated with the Scell.

Aspect 2: The method of Aspect 1, wherein receiving the indication to activate or deactivate the cell DTX or cell DRX for the Pcell includes receiving an indication to activate the cell DTX or cell DRX for the Pcell, and wherein skipping, or monitoring for, the reception or transmission of the one or more channels associated with the Scell includes skipping, based at least in part on the indication to activate the cell DTX or cell DRX for the Pcell, the reception or transmission of the one or more channels associated with the Scell.

Aspect 3: The method of Aspect 2, wherein skipping the reception or transmission of the one or more channels associated with the Scell includes refraining from monitoring a PDCCH associated with the Scell.

Aspect 4: The method of Aspect 2, wherein skipping the reception or transmission of the one or more channels associated with the Scell includes skipping the reception or transmission of the one or more channels associated with the Scell based at least in part on cell DTX or cell DRX for the Scell.

Aspect 5: The method of Aspect 4, wherein skipping the reception or transmission of the one or more channels associated with the Scell includes skipping the reception or transmission of the one or more channels associated with the Scell beginning at a start time of a non-active period of the cell DTX or cell DRX for the Scell, wherein the start time occurs after the cell DTX or cell DRX for the Pcell is activated.

Aspect 6: The method of the Aspect 4, further comprising: receiving an indication to deactivate the cell DTX or cell DRX for the Pcell; and monitoring, based at least in part on the indication to deactivate the cell DTX or cell DRX for the Pcell, a PDCCH associated with the Scell beginning at a start time of an active period of the cell discontinuous transmission or cell discontinuous reception for the Scell, wherein the start time occurs after the cell DTX or cell DRX for the Pcell is deactivated.

Aspect 7: The method of Aspect 2, wherein skipping the reception or transmission of the one or more channels associated with the Scell includes refraining from monitoring a PDCCH associated with the Scell and refraining from monitoring for or transmitting scheduled uplink or downlink data associated with the Scell.

Aspect 8: The method of Aspect 7, wherein skipping the reception or transmission of the one or more channels associated with the Scell further includes refraining from monitoring for CSI-RSs associated with the Scell and with one or more of BM or CSI, and wherein skipping the reception or transmission of the one or more channels associated with the Scell further includes refraining from transmitting a CSI report.

Aspect 9: The method of Aspect 2, wherein skipping the reception or transmission of the one or more channels associated with the Scell includes skipping the reception or transmission of the one or more channels associated with the Scell beginning at a first time at which the cell DTX or cell DRX for the Pcell is activated or at a second time that is offset from the first time.

Aspect 10: The method of any of Aspects 1-9, further comprising: receiving an indication of one or more Scells including the Scell, wherein skipping, or monitoring for, the reception or transmission of the one or more channels includes skipping, or monitoring for, the reception or transmission of the one or more channels associated with the Scell based at least in part on the indication of the one or more Scells.

Aspect 11: The method of the any of Aspects 1-10, wherein receiving the indication to activate or deactivate the cell DTX or cell DRX for the Pcell includes receiving an indication to deactivate the cell DTX or cell DRX for the Pcell, and wherein skipping, or monitoring for, the reception or transmission of the one or more channels associated with the Scell includes monitoring for, based at least in part on the indication to deactivate the cell DTX or cell DRX for the Pcell, the reception or transmission of the one or more channels associated with the Scell.

Aspect 12: The method of Aspect 11, wherein monitoring for the reception or transmission of the one or more channels associated with the Scell includes monitoring a PDCCH associated with the Scell based at least in part on the indication to deactivate the cell DTX or cell DRX for the Pcell.

Aspect 13: The method of Aspect 12, wherein monitoring the PDCCH includes monitoring the PDCCH beginning at a first time at which the cell DTX or cell DRX for the Pcell is deactivated or at a second time that is offset from the first time.

Aspect 14: A method of wireless communication performed by a network node, comprising: transmitting a configuration of cell DTX or cell DRX; transmitting a configuration of CA associated with a Pcell and an Scell; transmitting an indication to activate or deactivate the cell DTX or cell DRX for the Pcell; and skipping reception or transmission of, or transmitting, based at least in part on the indication to activate or deactivate the cell DTX or cell DRX for the Pcell, one or more channels associated with the Scell.

Aspect 15: The method of Aspect 14, wherein transmitting the indication to activate or deactivate the cell DTX or cell DRX for the Pcell includes transmitting an indication to activate the cell DTX or cell DRX for the Pcell, and wherein skipping the reception or transmission of, or transmitting, the one or more channels associated with the Scell includes skipping, based at least in part on the indication to activate the cell DTX or cell DRX for the Pcell, the reception or transmission of the one or more channels associated with the Scell.

Aspect 16: The method of Aspect 15, wherein skipping the reception or transmission of the one or more channels associated with the Scell includes refraining from transmitting a PDCCH associated with the Scell.

Aspect 17: The method of Aspect 15, wherein skipping the reception or transmission of the one or more channels associated with the Scell includes skipping the reception or transmission of the one or more channels associated with the Scell based at least in part on cell DTX or cell DRX for the Scell.

Aspect 18: The method of Aspect 15, wherein skipping the reception or transmission of the one or more channels associated with the Scell includes refraining from transmitting a PDCCH associated with the Scell and refraining from monitoring for or transmitting scheduled uplink or downlink data associated with the Scell.

Aspect 19: The method of Aspect 18, wherein skipping the reception or transmission of the one or more channels associated with the Scell further includes refraining from transmitting CSI-RSs associated with the Scell and with one or more of BM or CSI, and wherein skipping the reception or transmission of the one or more channels associated with the Scell further includes refraining from monitoring for a CSI report.

Aspect 20: The method of any of Aspects 14-19, further comprising: transmitting an indication of one or more Scells including the Scell, wherein skipping the reception or transmission of, or transmitting, the one or more channels includes skipping the reception or transmission of, or transmitting, the one or more channels associated with the Scell based at least in part on the indication of the one or more Scells.

Aspect 21: The method of the any of Aspects 14-20, wherein transmitting the indication to activate or deactivate the cell DTX or cell DRX for the Pcell includes transmitting an indication to deactivate the cell DTX or cell DRX for the Pcell, and wherein skipping the reception or transmission of, or transmitting, the one or more channels associated with the Scell includes transmitting, based at least in part on the indication to deactivate the cell DTX or cell DRX for the Pcell, the one or more channels associated with the Scell.

Aspect 22: The method of Aspect 21, wherein transmitting the one or more channels associated with the Scell includes transmitting a PDCCH associated with the Scell based at least in part on the indication to deactivate the cell DTX or cell DRX for the Pcell.

Aspect 23: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-22.

Aspect 24: An apparatus for wireless communication at a device, the apparatus comprising one or more memories and one or more processors coupled to the one or more memories, the one or more processors configured to cause the device to perform the method of one or more of Aspects 1-22.

Aspect 25: An apparatus for wireless communication, the apparatus comprising at least one means for performing the method of one or more of Aspects 1-22.

Aspect 26: A non-transitory computer-readable medium storing code for wireless communication, the code comprising instructions executable by one or more processors to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

Aspect 28: A device for wireless communication, the device comprising a processing system that includes one or more processors and one or more memories coupled with the one or more processors, the processing system configured to cause the device to perform the method of one or more of Aspects 1-22.

Aspect 29: An apparatus for wireless communication at a device, the apparatus comprising one or more memories and one or more processors coupled to the one or more memories, the one or more processors individually or collectively configured to cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to cause the UE to:
receive a configuration of cell discontinuous transmission or cell discontinuous reception;
receive a configuration of carrier aggregation associated with a primary cell (Pcell) and a secondary cell (Scell);
receive an indication to activate or deactivate the cell discontinuous transmission or cell discontinuous reception for the Pcell; and
skip, or monitor for, based at least in part on the indication to activate or deactivate the cell discontinuous transmission or cell discontinuous reception for the Pcell, reception or transmission of one or more channels associated with the Scell.

2. The UE of claim 1, wherein the one or more processors, to cause the UE to receive the indication to activate or deactivate the cell discontinuous transmission or cell discontinuous reception for the Pcell, are configured to cause the UE to receive an indication to activate the cell discontinuous transmission or cell discontinuous reception for the Pcell, and
wherein the one or more processors, to cause the UE to skip, or monitor for, the reception or transmission of the one or more channels associated with the Scell, are configured to cause the UE to skip, based at least in part on the indication to activate the cell discontinuous transmission or cell discontinuous reception for the Pcell, the reception or transmission of the one or more channels associated with the Scell.

3. The UE of claim 2, wherein the one or more processors, to cause the UE to skip the reception or transmission of the one or more channels associated with the Scell, are configured to cause the UE to refrain from monitoring a physical downlink control channel (PDCCH) associated with the Scell.

4. The UE of claim 2, wherein the one or more processors, to cause the UE to skip the reception or transmission of the one or more channels associated with the Scell, are configured to cause the UE to skip the reception or transmission of the one or more channels associated with the Scell based at least in part on cell discontinuous transmission or cell discontinuous reception for the Scell.

5. The UE of claim 4, wherein the one or more processors, to cause the UE to skip the reception or transmission of the one or more channels associated with the Scell, are configured to cause the UE to skip the reception or transmission of the one or more channels associated with the Scell beginning at a start time of a non-active period of the cell discontinuous transmission or cell discontinuous reception for the Scell, wherein the start time occurs after the cell discontinuous transmission or cell discontinuous reception for the Pcell is activated.

6. The UE of claim 4, wherein the one or more processors are further configured to cause the UE to:
receive an indication to deactivate the cell discontinuous transmission or cell discontinuous reception for the Pcell; and
monitor, based at least in part on the indication to deactivate the cell discontinuous transmission or cell discontinuous reception for the Pcell, a physical downlink control channel (PDCCH) associated with the Scell beginning at a start time of an active period of the cell discontinuous transmission or cell discontinuous reception for the Scell, wherein the start time occurs after the cell discontinuous transmission or cell discontinuous reception for the Pcell is deactivated.

7. The UE of claim 2, wherein the one or more processors, to cause the UE to skip the reception or transmission of the one or more channels associated with the Scell, are configured to cause the UE to refrain from monitoring a physical downlink control channel (PDCCH) associated with the Scell and refrain from monitoring for or transmitting scheduled uplink or downlink data associated with the Scell.

8. The UE of claim 7, wherein the one or more processors, to cause the UE to skip the reception or transmission of the one or more channels associated with the Scell, are further configured to cause the UE to refrain from monitoring for channel state information reference signals (CSI-RSs) associated with the Scell and with one or more of beam management or channel state information (CSI), and wherein the one or more processors, to cause the UE to skip the reception or transmission of the one or more channels associated with the Scell, are further configured to cause the UE to refrain from transmitting a CSI report.

9. The UE of claim 2, wherein the one or more processors, to cause the UE to skip the reception or transmission of the one or more channels associated with the Scell, are configured to cause the UE to skip the reception or transmission of the one or more channels associated with the Scell beginning at a first time at which the cell discontinuous transmission or cell discontinuous reception for the Pcell is activated or at a second time that is offset from the first time.

10. The UE of claim 1, wherein the one or more processors are further configured to cause the UE to:
receive an indication of one or more Scells including the Scell,
wherein the one or more processors, to cause the UE to skip, or monitor for, the reception or transmission of the one or more channels, are configured to cause the UE to skip, or monitor for, the reception or transmission of the one or more channels associated with the Scell based at least in part on the indication of the one or more Scells.

11. The UE of claim 1, wherein the one or more processors, to cause the UE to receive the indication to activate or deactivate the cell discontinuous transmission or cell discontinuous reception for the Pcell, are configured to cause the UE to receive an indication to deactivate the cell discontinuous transmission or cell discontinuous reception for the Pcell, and
wherein the one or more processors, to cause the UE to skip, or monitor for, the reception or transmission of the one or more channels associated with the Scell, are configured to cause the UE to monitor for, based at least in part on the indication to deactivate the cell discontinuous transmission or cell discontinuous reception for the Pcell, the reception or transmission of the one or more channels associated with the Scell.

12. The UE of claim 11, wherein the one or more processors, to cause the UE to monitor for the reception or transmission of the one or more channels associated with the Scell, are configured to cause the UE to monitor a physical downlink control channel (PDCCH) associated with the Scell based at least in part on the indication to deactivate the cell discontinuous transmission or cell discontinuous reception for the Pcell.

13. The UE of claim 12, wherein the one or more processors, to cause the UE to monitor the PDCCH, are configured to cause the UE to monitor the PDCCH beginning at a first time at which the cell discontinuous transmission or cell discontinuous reception for the Pcell is deactivated or at a second time that is offset from the first time.

14. A network node for wireless communication, comprising:
one or more memories; and
one or more processors, coupled to the one or more memories, configured to cause the network node to:
transmit a configuration of cell discontinuous transmission or cell discontinuous reception;
transmit a configuration of carrier aggregation associated with a primary cell (Pcell) and a secondary cell (Scell);
transmit an indication to activate or deactivate the cell discontinuous transmission or cell discontinuous reception for the Pcell; and
skip reception or transmission of, or transmit, based at least in part on the indication to activate or deactivate the cell discontinuous transmission or cell discontinuous reception for the Pcell, one or more channels associated with the Scell.

15. The network node of claim 14, wherein the one or more processors, to cause the network node to transmit the indication to activate or deactivate the cell discontinuous transmission or cell discontinuous reception for the Pcell, are configured to cause the network node to transmit an indication to activate the cell discontinuous transmission or cell discontinuous reception for the Pcell, and
wherein the one or more processors, to cause the network node to skip the reception or transmission of, or transmit, the one or more channels associated with the Scell, are configured to cause the network node to skip, based at least in part on the indication to activate the cell discontinuous transmission or cell discontinuous reception for the Pcell, the reception or transmission of the one or more channels associated with the Scell.

16. The network node of claim 15, wherein the one or more processors, to cause the network node to skip the reception or transmission of the one or more channels associated with the Scell, are configured to cause the network node to refrain from transmitting a physical downlink control channel (PDCCH) associated with the Scell.

17. The network node of claim 15, wherein the one or more processors, to cause the network node to skip the reception or transmission of the one or more channels associated with the Scell, are configured to cause the network node to skip the reception or transmission of the one or more channels associated with the Scell based at least in part on cell discontinuous transmission or cell discontinuous reception for the Scell.

18. The network node of claim 15, wherein the one or more processors, to cause the network node to skip the reception or transmission of the one or more channels associated with the Scell, are configured to cause the network node to refrain from transmitting a physical downlink control channel (PDCCH) associated with the Scell and refrain from monitoring for or transmitting scheduled uplink or downlink data associated with the Scell.

19. The network node of claim 18, wherein the one or more processors, to cause the network node to skip the reception or transmission of the one or more channels associated with the Scell, are further configured to cause the network node to refrain from transmitting channel state information reference signals (CSI-RSs) associated with the Scell and with one or more of beam management or channel state information (CSI), and wherein the one or more processors, to cause the network node to skip the reception or transmission of the one or more channels associated with the Scell, are further configured to cause the network node to refrain from monitoring for a CSI report.

20. The network node of claim 14, wherein the one or more processors are further configured to cause the network node to:
transmit an indication of one or more Scells including the Scell,
wherein the one or more processors, to cause the network node to skip the reception or transmission of, or transmit, the one or more channels, are configured to cause the network node to skip the reception or transmission of, or transmit, the one or more channels associated with the Scell based at least in part on the indication of the one or more Scells.

21. The network node of claim 14, wherein the one or more processors, to cause the network node to transmit the indication to activate or deactivate the cell discontinuous transmission or cell discontinuous reception for the Pcell, are configured to cause the network node to transmit an indication to deactivate the cell discontinuous transmission or cell discontinuous reception for the Pcell, and
wherein the one or more processors, to cause the network node to skip the reception or transmission of, or transmit, the one or more channels associated with the Scell, are configured to cause the network node to transmit, based at least in part on the indication to deactivate the cell discontinuous transmission or cell discontinuous reception for the Pcell, the one or more channels associated with the Scell.

22. The network node of claim 21, wherein the one or more processors, to cause the network node to transmit the one or more channels associated with the Scell, are configured to cause the network node to transmit a physical downlink control channel (PDCCH) associated with the Scell based at least in part on the indication to deactivate the cell discontinuous transmission or cell discontinuous reception for the Pcell.

23. A method of wireless communication performed by a user equipment (UE), comprising:
receiving a configuration of cell discontinuous transmission or cell discontinuous reception;
receiving a configuration of carrier aggregation associated with a primary cell (Pcell) and a secondary cell (Scell);
receiving an indication to activate or deactivate the cell discontinuous transmission or cell discontinuous reception for the Pcell; and
skipping, or monitoring for, based at least in part on the indication to activate or deactivate the cell discontinuous transmission or cell discontinuous reception for the Pcell, reception or transmission of one or more channels associated with the Scell.

24. The method of claim 23, wherein receiving the indication to activate or deactivate the cell discontinuous transmission or cell discontinuous reception for the Pcell includes receiving an indication to activate the cell discontinuous transmission or cell discontinuous reception for the Pcell, and
wherein skipping, or monitoring for, the reception or transmission of the one or more channels associated with the Scell includes skipping, based at least in part on the indication to activate the cell discontinuous transmission or cell discontinuous reception for the Pcell, the reception or transmission of the one or more channels associated with the Scell.

25. The method of claim 24, wherein skipping the reception or transmission of the one or more channels associated with the Scell includes refraining from monitoring a physical downlink control channel (PDCCH) associated with the Scell.

26. The method of claim 24, wherein skipping the reception or transmission of the one or more channels associated with the Scell includes skipping the reception or transmission of the one or more channels associated with the Scell based at least in part on cell discontinuous transmission or cell discontinuous reception for the Scell.

27. The method of claim 24, wherein skipping the reception or transmission of the one or more channels associated with the Scell includes refraining from monitoring a physical downlink control channel (PDCCH) associated with the Scell and refraining from monitoring for or transmitting scheduled uplink or downlink data associated with the Scell.

28. A method of wireless communication performed by a network node, comprising:
transmitting a configuration of cell discontinuous transmission or cell discontinuous reception;
transmitting a configuration of carrier aggregation associated with a primary cell (Pcell) and a secondary cell (Scell);
transmitting an indication to activate or deactivate the cell discontinuous transmission or cell discontinuous reception for the Pcell; and
skipping reception or transmission of, or transmitting, based at least in part on the indication to activate or deactivate the cell discontinuous transmission or cell discontinuous reception for the Pcell, one or more channels associated with the Scell.

29. The method of claim 28, wherein transmitting the indication to activate or deactivate the cell discontinuous transmission or cell discontinuous reception for the Pcell includes transmitting an indication to activate the cell discontinuous transmission or cell discontinuous reception for the Pcell, and
wherein skipping the reception or transmission of, or transmitting, the one or more channels associated with the Scell includes skipping, based at least in part on the indication to activate the cell discontinuous transmission or cell discontinuous reception for the Pcell, the reception or transmission of the one or more channels associated with the Scell.

30. The method of the claim 28, wherein transmitting the indication to activate or deactivate the cell discontinuous transmission or cell discontinuous reception for the Pcell includes transmitting an indication to deactivate the cell discontinuous transmission or cell discontinuous reception for the Pcell, and
wherein skipping the reception or transmission of, or transmitting, the one or more channels associated with the Scell includes transmitting, based at least in part on the indication to deactivate the cell discontinuous transmission or cell discontinuous reception for the Pcell, the one or more channels associated with the Scell.
